(19) United States
(12) Patent Application Publication
(10) Pub. No.: US 2022/0143909 A1
(43) Pub. Date: May 12, 2022

(54) APPARATUS, SYSTEM AND METHOD FOR ULTRASONIC-BASED ADDITIVE MANUFACTURING

(71) Applicant: JABIL INC., St. Petersburg, FL (US)

(72) Inventor: Luke Rodgers, St. Petersburg, FL (US)

(73) Assignee: JABIL INC., St. Petersburg, FL (US)

(21) Appl. No.: 17/417,094

(22) PCT Filed: Dec. 19, 2019
(86) PCT No.: PCT/US19/67312

§ 371 Date: Jun. 21, 2021

Related U.S. Application Data
(60) Provisional application No. 62/782,654, filed on Dec. 20, 2018.

(51) Int. Cl. B29C 64/209; B29C 64/153; B29C 64/295; B33Y 30/00

(52) U.S. Cl. CPC B29C 64/209; B33Y 30/00; B29C 64/295; B29C 64/153

(57) ABSTRACT

An apparatus, system and method of using ultrasonic energy for additive manufacturing. The apparatus, system and method may include comprising: a print bed of print material responsive to ultrasonic energy; and an ultrasonic print head suitable to deliver the ultrasonic energy to the print bed to thereby form the print material into a printed output according to a print plan that exerts control over the ultrasonic print head.

### CROSS-REFERENCE TO RELATED APPLICATIONS

The present application claims benefit of priority to International Application No. PCT/US2019/067312, filed Dec. 19, 2019; entitled: Apparatus, System and Method for Ultrasonic Based Additive Manufacturing,” U.S. Provisional Application No. 62/782,654, filed Dec. 20, 2018, entitled: “Apparatus, System and Method for Ultrasonic Based Additive Manufacturing,” the entirety of which is incorporated herein by reference as if set forth in its entirety.

### BACKGROUND

### Field of the Disclosure

The present disclosure relates to additive manufacturing, and, more specifically, to an apparatus, system and method for ultrasonic-based additive manufacturing.

### Description of the Background

Three-dimensional (3D) printing is any of various processes in which material is joined or solidified under computer control to create a three-dimensional object. The 3D print material is “added” onto a base, such as in the form of added liquid molecules or layers of powder grain or melted feed material, and upon successive fusion of the print material to the base, the 3D object is formed. 3D printing is thus a subset of additive manufacturing (AM).

A 3D printed object may be of almost any shape or geometry, and typically the computer control that oversees the creation of the 3D object executes from a digital data model or similar additive manufacturing file (AMF) file, i.e., a “print plan”. Usually this AMF is executed on a layer-by-layer basis, and may include control of other hardware used to form the layers, such as lasers or heat sources.

There are many different technologies that are used to execute the AMF. Exemplary technologies may include: fused deposition modeling (FDM); stereolithography (SLA); digital light processing (DLP); selective laser sintering (SLS); selective laser melting (SLM); high speed sintering (HSS); inkjet print and/or particle jetting manufacturing (IPM); laminated object manufacturing (LOM); and electronic beam melting (EBM).

Some of the foregoing methods melt or soften the print material to produce the print layers. For example, in FDM, the 3D object is produced by extruding small beads or streams of material which harden to form layers. A filament of thermoplastic, wire, or other material is fed into an extrusion nozzle head, which typically heats the material and turns the flow on and off.

Other methods, such as laser or similar beam-based or sintering techniques, may heat or otherwise activate the print material, such as a print powder, for the purpose of fusing the powder granules into layers. For example, such methods may melt the powder using a high-energy laser to create fully dense materials that may have mechanical properties similar to those of conventional manufacturing methods. SLS, for example, uses a laser to solidify and bond grains of plastic, ceramic, glass, metal or other materials into layers to produce the 3D object. The laser traces the pattern of each layer slice into the bed of powder, the bed then lowers, and another layer is traced and bonded on top of the previous.

In contrast, other similar methods, such as IPM, may create the 3D object one layer at a time by spreading a layer of powder, and printing a binder in the cross-section of the 3D object. This binder may be printed using an inkjet-like process.

By way of further example, and as will be appreciated by the skilled artisan, In a manner similar to SLS, high speed sintering (HSS) employs part formation through the use of targeted heat, such as from infrared (IR) lamps. More specifically, a part for production is, virtually-speaking, “sliced” into layers in the print plan, as discussed throughout, and these virtual layers then become actual layers upon application of the IR by the print process to the treated areas of a print bed.

That is, HSS typically occurs using a “bed” of powdered print material. The print plan may select one or more locations within the powder bed that will serve as part generation locations. Each part layer is “printed” onto the part generation pattern in the powder bed using a heat-absorbing ink. In a typical process, a broadband IR lamp then delivers heat across the entire print bed. This heat is absorbed by the heat absorbing ink, thereby forming a part layer having only those shaped characteristics indicated by the pattern of the ink placed upon the powder bed, as referenced above. The foregoing process then repeats, layer by layer, until the completed part is formed.

### SUMMARY

The embodiments are and include at least an apparatus, system and method of using ultrasonic energy for additive manufacturing. The apparatus, system and method may include comprising: a print bed of print material responsive to ultrasonic energy; and an ultrasonic print head suitable to deliver the ultrasonic energy to the print bed to thereby form the print material into a printed output according to a print plan that exerts control over the ultrasonic print head.

### BRIEF DESCRIPTION OF THE DRAWINGS

The disclosed non-limiting embodiments are discussed in relation to the drawings appended hereto and forming part hereof, wherein like numerals indicate like elements, and in which:

FIG. 1 is an illustration of an additive manufacturing system;

FIG. 2 illustrates an exemplary computing system; and

FIG. 3 illustrates aspects of the exemplary embodiments.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “engaged to”, “connected to” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments.

Wire bonding is a known method of making interconnections in electronics, typically between an integrated circuit or similar semi-conductor device and its packaging, during semi-conductor device fabrication. Often in wire bonding, the aforementioned materials are bonded together using heat and pressure that results from the application of ultrasonic energy, also referred to as thermosonic bonding.

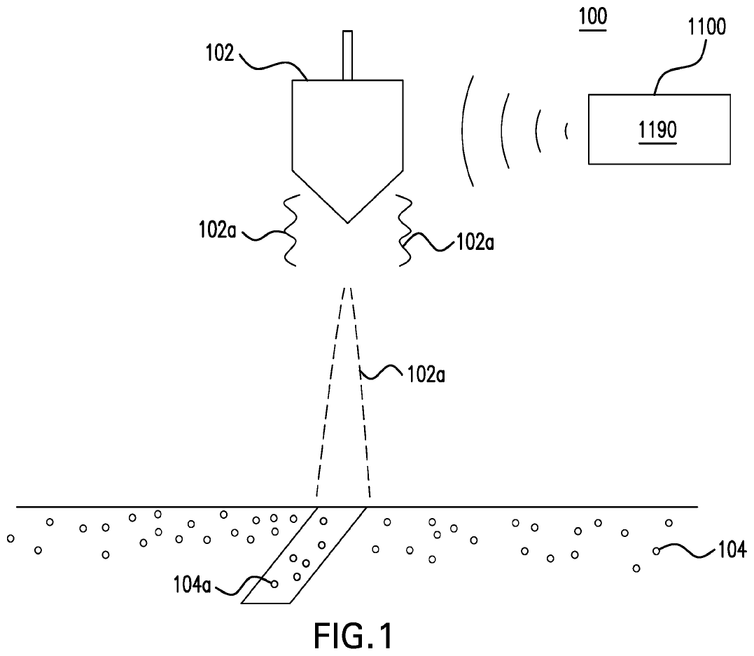

In accordance with the foregoing and as illustrated in FIG. 1, the embodiments of system 100 provide a sintering/heating print head 102 that employs ultrasonic heating 102a to apply the requisite energy to a powdered print material 104, such that the powdered printed material 104 is formed in-layer into a pattern indicated by a print plan 1190. As illustrated, the embodiments may include, by way of non-limiting example, a powder bed 104 similar to that provided in SLS or HSS printing, as discussed above. Ultrasonic energy head 102 then applies ultrasonic energy 102a in a targeted manner to the powder bed 104 while being subjected to movement of the print head 102 in the x, y and/or z axis, as dictated by the print plan 1190. The ultrasonic energy head 102 may be in contact with or in direct contact with the powdered print material 104.

As will be appreciated by the skilled artisan, substantial numbers of materials are responsive to the application of ultrasonic energy 102a, such that said materials 104a may be melted, welded, and/or sintered in a manner akin to the SLS or HSS printing of the known art. Accordingly, available print materials 104a in the embodiments constitute a substantially greater set of materials than the subset of materials suitable for SLS or HSS printing. By way of example, because of the availability of ultrasonic energy 102a and its suitability to perform welding in a manner similar to that performed in wire bonding, print materials may include non-polymer materials, such as metals and the like.

Of note, the ultrasonic energy 102a may be applied by any known methodology, such as an ultrasonic horn. As is the case with SLS and HSS printing, it may be desirable that the print plan not allow the ultrasonic horn to stagnate in one location because, if the ultrasonic print head does not keep moving, the print material may clump or burn in a manner similar to SLS or HSS.

It will be understood that particular print materials may be optimally responsive to particular ultrasonic wavelengths, and/or that particular ultrasonic wavelengths may create material bonds to a greater depth, and hence of greater strength, in a bed formed of certain types of materials, and thus that the application of ultrasonic energy may be tunable in the embodiments. By way of example, particular ultrasonic horns having certain wavelengths or wavelength ranges may be corresponded to certain types of print material, and may be manually or automatically selectable in accordance with the print plan 1190 discussed throughout. Similarly, a broadband ultrasonic horn may be employed in the embodiments, but may be subjected to acoustic filtering that is low pass, band pass, or high pass, such that only the most desired range of ultrasonic energy is delivered to a print material 104a optimized to that range.

The ultrasonic print head 102 may consume less energy than, for example, the laser employed in SLS printing. Further, the ultrasonic print head 102 may be enabled to apply its energy at a highly optimized wavelength, such as through the horn tuning discussed above, and hence may be suitable to move significantly faster while engaged in actuating the print plan 1190 than are print heads in the known art. Correspondingly, the disclosed ultrasonic print head 102 may provide far more expedient additive manufacturing than is provided by the known art.

Of course, it will be appreciated by the skilled artisan, in light of the discussion above, that other types of printing, such as FDM, may employ a filament feed to the disclosed ultrasonic print head. That is, such a filament feedsource may be liquefied by the ultrasonic head to allow for printing.

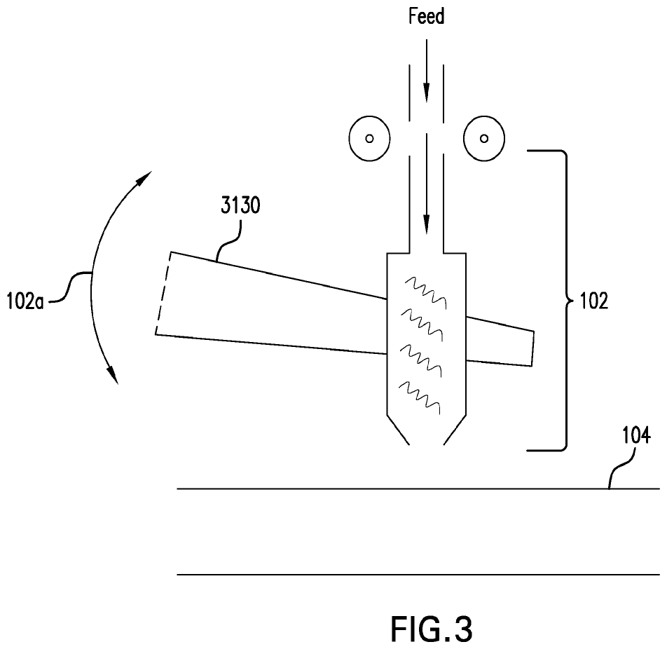

As noted above in relation to FIG. 1, the ultrasonic energy head 102 may be in contact with or in direct contact with the powdered print material 104. This may be based on the alternating ultrasonic motion imparted by the ultrasonic horn 3130, as is illustrated in FIG. 3.

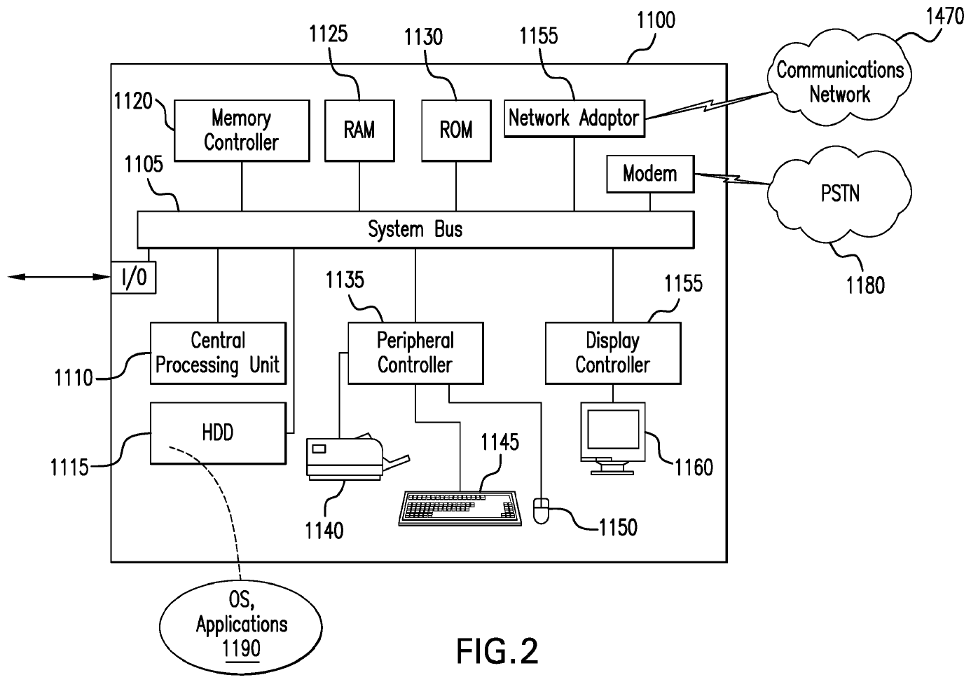

FIG. 2 depicts an exemplary computing and control system 1100 for use in association with the herein described systems and methods. Computing system 1100 is capable of executing software, such as an operating system (OS) and/or one or more computing applications/algorithms 1190, such as applications applying the print plan, monitoring, process controls, process monitoring, and process modifications discussed herein, and may execute such applications 1190 using data, such as materials and process-related data, which may be stored 1115 locally or remotely.

More particularly, the operation of an exemplary computing system 1100 is controlled primarily by computer readable instructions, such as instructions stored in a computer readable storage medium, such as hard disk drive (HDD) 1115, optical disk (not shown) such as a CD or DVD, solid state drive (not shown) such as a USB “thumb drive,” or the like. Such instructions may be executed within central processing unit (CPU) 1110 to cause computing system 1100 to perform the operations discussed throughout. In many known computer servers, workstations, personal computers, and the like, CPU 1110 is implemented in an integrated circuit called a processor.

It is appreciated that, although exemplary computing system 1100 is shown to comprise a single CPU 1110, such description is merely illustrative, as computing system 1100 may comprise a plurality of CPUs 1110. Additionally, computing system 1100 may exploit the resources of remote CPUs (not shown), for example, through communications network 1170 or some other data communications means.

In operation, CPU 1110 fetches, decodes, and executes instructions from a computer readable storage medium, such as HDD 1115. Such instructions may be included in software, such as an operating system (OS), executable programs such as the aforementioned correlation applications, and the like. Information, such as computer instructions and other computer readable data, is transferred between components of computing system 1100 via the system's main data-transfer path. The main data-transfer path may use a system bus architecture 1105, although other computer architectures (not shown) can be used, such as architectures using serializers and deserializers and crossbar switches to communicate data between devices over serial communication paths. System bus 1105 may include data lines for sending data, address lines for sending addresses, and control lines for sending interrupts and for operating the system bus. Some busses provide bus arbitration that regulates access to the bus by extension cards, controllers, and CPU 1110.

Memory devices coupled to system bus 1105 may include random access memory (RAM) 1125 and/or read only memory (ROM) 1130. Such memories include circuitry that allows information to be stored and retrieved. ROMs 1130 generally contain stored data that cannot be modified. Data stored in RAM 1125 can be read or changed by CPU 1110 or other hardware devices. Access to RAM 1125 and/or ROM 1130 may be controlled by memory controller 1120. Memory controller 1120 may provide an address translation function that translates virtual addresses into physical addresses as instructions are executed. Memory controller 1120 may also provide a memory protection function that isolates processes within the system and isolates system processes from user processes. Thus, a program running in user mode may normally access only memory mapped by its own process virtual address space; in such instances, the program cannot access memory within another process' virtual address space unless memory sharing between the processes has been set up.

In addition, computing system 1100 may contain peripheral communications bus 1135, which is responsible for communicating instructions from CPU 1110 to, and/or receiving data from, peripherals, such as peripherals 1140, 1145, and 1150, which may include printers, keyboards, and/or the sensors discussed herein throughout. An example of a peripheral bus is the Peripheral Component Interconnect (PCI) bus.

Display 1160, which is controlled by display controller 1155, may be used to display visual output and/or other presentations generated by or at the request of computing system 1100, such as in the form of a GUI, responsive to operation of the aforementioned computing program(s). Such visual output may include text, graphics, animated graphics, and/or video, for example. Display 1160 may be implemented with a CRT-based video display, an LCD or LED-based display, a gas plasma-based flat-panel display, a touch-panel display, or the like. Display controller 1155 includes electronic components required to generate a video signal that is sent to display 1160.

Further, computing system 1100 may contain network adapter 1165 which may be used to couple computing system 1100 to external communication network 1170, which may include or provide access to the Internet, an intranet, an extranet, or the like. Communications network 1170 may provide user access for computing system 1100 with means of communicating and transferring software and information electronically. Additionally, communications network 1170 may provide for distributed processing, which involves several computers and the sharing of workloads or cooperative efforts in performing a task. It is appreciated that the network connections shown are exemplary and other means of establishing communications links between computing system 1100 and remote users may be used.

Network adaptor 1165 may communicate to and from network 1170 using any available wired or wireless technologies. Such technologies may include, by way of non-limiting example, cellular, Wi-Fi, Bluetooth, infrared, or the like.

It is appreciated that exemplary computing system 1100 is merely illustrative of a computing environment in which the herein described systems and methods may operate, and does not limit the implementation of the herein described systems and methods in computing environments having differing components and configurations. That is to say, the inventive concepts described herein may be implemented in various computing environments using various components and configurations.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. An apparatus for additive manufacturing printing, comprising:
a print bed of print material responsive to ultrasonic energy; and
an ultrasonic print head suitable to deliver the ultrasonic energy to the print bed to thereby form the print material into a printed output according to a print plan that exerts control over the ultrasonic print head.
